(19) United States
(12) Patent Application Publication
(10) Pub. No.: US 2025/0282247 A1
(43) Pub. Date: Sep. 11, 2025

(54) NON-CONTACT CHARGE CONTROL DEVICE

(71) Applicant: TOYOTA JIDOSHA KABUSHIKI KAISHA, Toyota-shi (JP)

(72) Inventor: Masato SHIGENAGA, Utsunomiyashi (JP)

(73) Assignee: TOYOTA JIDOSHA KABUSHIKI KAISHA, Toyota-shi (JP)

(21) Appl. No.: 19/010,447

(22) Filed: Jan. 6, 2025

(30) Foreign Application Priority Data
Mar. 5, 2024 (JP) 2024-033344

(51) Int. Cl. B60L 53/66; B60L 53/62

(52) U.S. Cl. CPC B60L 53/66; B60L 53/62

(57) ABSTRACT

A non-contact charge control device for a noncontact charge system that uses wireless communication to transmit power contactlessly from a power transmission device to a power receiving device, the non-contact charge control device includes a processor to, when the wireless communication is interrupted during charging that power, transmitted from the power transmission device and received by a power receiving unit of the power receiving device, is charged to a battery, stop the transmission of the power from the power transmission device and disconnect the wireless communication while maintaining a relay in a connecting state, the relay being provided for switching a connecting state between the power receiving unit and the battery, and resume, after resuming the wireless communication, the power transmission from the power transmission device while maintaining the connecting state of the relay.

### CROSS-REFERENCE TO RELATED APPLICATION(S)

The present application claims priority to and incorporates by reference the entire contents of Japanese Patent Application No. 2024-033344 filed in Japan on Mar. 5, 2024.

### BACKGROUND

The present disclosure relates to a non-contact charge control device.

Japanese Laid-open Patent Publication No. 2016-059197 discloses a non-contact power receiving device including a charging relay for switching the connection state between the power receiving device and the battery. The charge relays are turned ON by an ECU of the vehicles when the batteries are charged by the power transmission device. In addition, the power transmission device and the power receiving device can communicate with each other by the communication unit.

### SUMMARY

There is a need for providing a non-contact charge control device capable of suppressing the consumption of life of the charging relay.

According to an embodiment, a non-contact charge control device for a noncontact charge system that uses wireless communication to transmit power contactlessly from a power transmission device to a power receiving device, includes a processor to, when the wireless communication is interrupted during charging that power, transmitted from the power transmission device and received by a power receiving unit of the power receiving device, is charged to a battery, stop the transmission of the power from the power transmission device and disconnect the wireless communication while maintaining a relay in a connecting state, the relay being provided for switching a connecting state between the power receiving unit and the battery, and resume, after resuming the wireless communication, the power transmission from the power transmission device while maintaining the connecting state of the relay.

### BRIEF DESCRIPTION OF THE DRAWINGS

FIG. 1 is a block diagram illustrating a schematic configuration of a wireless power transmission system including a contactless charging control device according to an embodiment;

FIG. 2 is a flowchart illustrating a process in the non-contact charge control device; and

FIG. 3 is a flowchart illustrating a determination method of whether to disable the position transmitter in the non-contact charge control device.

### DETAILED DESCRIPTION

In the related art, in a non-contact charging system that transmits power from a power transmission device to a power receiving device in a non-contact manner using radio communication between the power transmission device and the power receiving device, if wireless communication between the power transmission device and the power receiving device is interrupted during charging, the charging relay is disconnected before the wireless communication is disconnected. Then reconnect the wireless communication and reconnect the charging relay to resume charging. In this situation, since ON/OFF of the charging relay each time the radio communication is interrupted, the life of the charging relay is consumed.

A non-contact charge control device according to an embodiment of the present disclosure will be described with reference to the drawings. In addition, components in the following embodiments include those which can be substituted and easily by those skilled in the art, or those which are substantially the same.

### Embodiment

### Configuration of the Wireless Power Transmission System

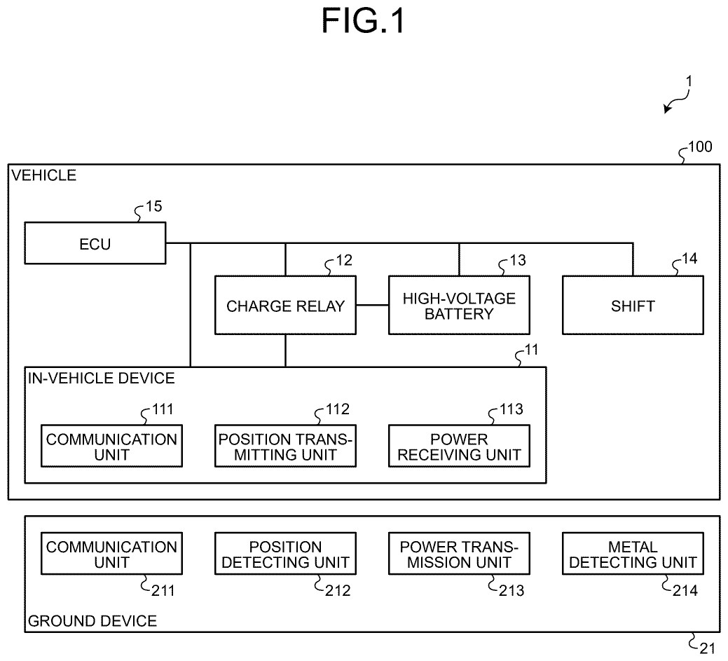

FIG. 1 is a block diagram illustrating a schematic configuration of a wireless power transmission system including a contactless charging control device according to an embodiment. A wireless power transmission system (wireless Power Transfer System) 1 in FIG. 1 includes a in-vehicle device 11, which is a power receiving device mounted on the vehicle 100, a ground device 21, which is a power transmission device for transmitting power from the ground to the vehicle 100. In the wireless power transmission system 1 of FIG. 1, by using a wireless communication, power is transmitted from the ground device 21 to the in-vehicle device 11 in a non-contact manner by the magnetic field resonance method. More specifically, power supply is achieved from the ground device 21 to the in-vehicle device 11 of the vehicle 100 by using a magnetic field resonance coupling (magnetic field resonance).

### Configuration of the Vehicle

Next, a configuration of the vehicle 100 is described. The vehicle 100 is an electric vehicle capable of charging power supplied from an external power source, such as a Battery Electric Vehicle (BEV) or a Plug-in Hybrid Electric Vehicle (PHEV), or the like. The vehicle 100 includes at least an in-vehicle device 11, a charge relay 12, a high-voltage battery 13, a shift 14, and an Electronic Control Unit (ECU) 15, which is a non-contact charge control device.

The in-vehicle device 11 includes a communication unit 111, a position transmitting unit 112, and a power receiving unit 113.

The communication unit 111 is configured by using an antenna and a predetermined communication module. The communication unit 111 performs radio communication with the communication unit 211 of the ground device 21 under the control of the ECU 15 according to a predetermined wireless communication standard. Here, the predetermined wireless communication standard is a communication distance is less than 10 meters. As a predetermined wireless communication standard, it is possible to use various short-range wireless communication having a short communication distance. For example, a communication conforming to any communication standard established by IEEE, ISO, IEC and the like is used.

As an example, Wi-Fi (registered trademark), Bluetooth (registered trademark), etc. are used.

The position transmitting unit 112 is configured using a position transmitter. The position transmitting unit 112, under the control of the ECU 15, transmits an electromagnetic wave for detecting the position by applying a voltage to the position transmitter.

The power receiving unit 113 receives the power transmitted in a non-contact manner from the power transmission unit 213 and supplies the received power to the high-voltage battery 13. The power receiving unit 113 is electrically connected to the high-voltage battery 13 via the charging relay 12. The power receiving unit 113 is constituted by using a secondary coil and a resonance capacitor or the like.

The charging relay 12 switches the connection state between the power receiving unit 113 and the high-voltage battery 13. The charging relay 12 is turned ON by the ECU 15 during charging from the Ground device 21 to the high-voltage battery 13 of the in-vehicle device 11, is turned OFF when the charging is completed.

The high-voltage battery 13 is an in-vehicle battery that can be externally charged. The high-voltage battery 13 is constituted by a secondary battery for storing power supplied from the power receiving unit 113.

The shift 14 is, for example, a shift lever of an AT vehicle, neutral “N” to disconnect the torque transmitted from the engine to the tires, a drive “D” to move the vehicle 100 forward, reverse “R” to retract the vehicle 100, parking for parking the vehicle 100 “P” or the like in accordance with the selected shift from, appropriately switching the gear or the like of the vehicle 100.

The ECU 15 is implemented using memories and a processor with hardware. The hardware may be, for example, memories, a Central Processing Unit (CPU), a Digital Signal Processor (DPS), and an Field-Programmable Gate Array (FPGA). The ECU 15 controls the components constituting the vehicles 100.

In a case where the power receiving unit 113 of the in-vehicle device 11 receives the power transmitted from the power transmission unit 213 of the ground device 21, and when the radio communication is interrupted during charging to charge the received power to the high voltage battery 13, the ECU 15 stops the transmission of power from the ground device 21, disconnects the wireless communication while remaining the connection of the charging relay 12. Thereafter, after resuming the radio connection, the ECU 15 resumes the transmission of power from the ground device 21 while the charge relay 12 is connected. Further, the ECU 15 applies a voltage to a position transmitter of the position transmitting unit 112 to transmit an electromagnetic wave for position detection. The ECU 15 detects the transmitted electromagnetic wave by the position detecting unit 212 an detects a positional deviation between the ground device 21 and the in-vehicle device 11. After that, in a case where the wireless communication is interrupted during charging, after resuming the wireless connection, if the vehicle 100 is in the state of being parked is continuing, the ECU 15 deactivates the position transmitter and resumes the transmission of power from the ground device 21.

### Configuration of the Ground Device

Next, a configuration of the ground device 21 is described. The ground device 21 transmits power to a vehicle 100 parked in a predetermined position, for example a parking space in a contactless manner. The ground device 21 includes at least a communication unit 211, a position detecting unit 212, a power transmission unit 213, and a metal detecting unit 214.

The communication unit 211 is configured by using an antenna and a predetermined communication module. The communication unit 211 performs radio communication with the communication unit 111 of the vehicle 100 according to a predetermined wireless communication standard.

The position detecting unit 212 detects the positional relationship between the in-vehicle device 11 and the ground device 21 by detecting the electromagnetic wave transmitted from the position transmitting unit 112.

The power transmission unit 213 has a primary coil, is disposed in the ground or on the ground surface such as a parking lot or roads. The power transmission unit 213 is electrically connected to an external AC power source, and transmits the power supplied from the AC power source in a non-contact manner.

The metal detecting unit 214 detects a metal foreign material between the power receiving unit 113 and the power transmission unit 213 by detecting a change in an electric field or the like.

### Process in the Non-Contact Charge Control Device

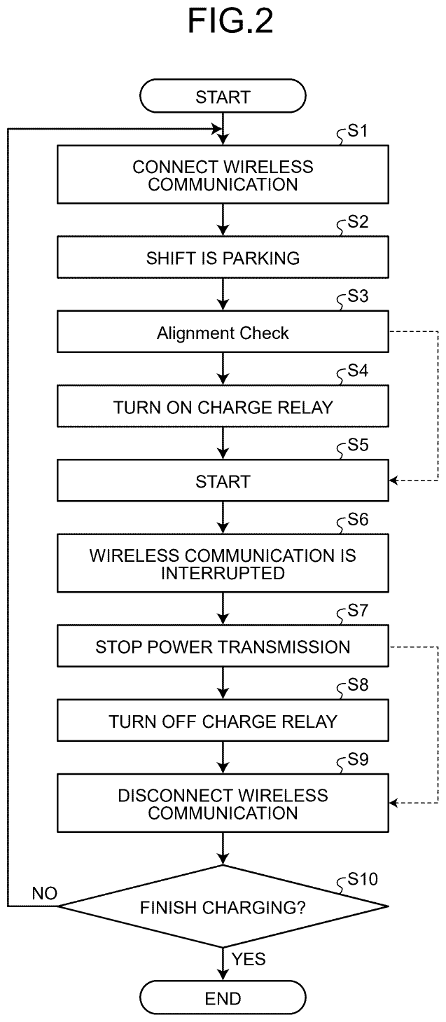

Next, a process of the ECU 15 is described. FIG. 2 is a flowchart illustrating a process in the non-contact charge control device. As illustrated in FIG. 2, the ECU 15 connects the radio communication between the communication unit 111 of the in-vehicle device 11 and the communication unit 211 of the ground device 21 (step S1).

Subsequently, the ECU 15 confirms that the position of the shifting 14 is parking and that parking of the vehicles 100 is completed (step S2).

Furthermore, the ECU 15 performs an Alignment Check for confirming whether the in-vehicle device 11 and the ground device 21 are aligned (position aligned) (step S3). The ECU 15 applies a voltage to the position transmitter of the position transmitting unit 112 to transmit an electromagnetic wave for position detection, receives a reception result by the position detecting unit 212 from the communication unit 111, and determines whether the in-vehicle device 11 and the ground device 21 are properly aligned. In the Alignment Check, when the in-vehicle device 11 and the ground device 21 are properly aligned, the determination of OK, if, however, the alignment is insufficient, the ECU 15 notifies to adjust the position of the vehicle 100.

When the determination of OK comes out in the Alignment Check, the ECU 15 electrically connects the power receiving unit 113 and the high-voltage battery 13 by turning ON the charge relay 12, so that power can be charged (step S4).

Then, the ECU 15 starts the power transmission (step S5). Specifically, the ECU 15 starts receiving power from the power transmission unit 213 by the power receiving unit 113 and charges the received power to the high-voltage battery 13.

Here, it is assumed that during charging, the ECU 15 detects that the radio communication between the communication unit 111 and the communication unit 211 is interrupted (step S6).

The ECU 15 then ceases power transfer (step S7). Specifically, the ECU 15 stops receiving power from the power transmission unit 213 by the power receiving unit 113.

Furthermore, the ECU 15 releases the electric connection between the power receiving unit 113 and the high-voltage battery 13 by turning OFF the charge relay (step S8).

Then, the ECU 15 disconnects the radio communication between the communication unit 111 and the communication unit 211 (step S9).

Thereafter, the ECU 15 determines whether to terminate the charge (step S10). The ECU 15, when it is determined to terminate the charge (Yes in step S10), ends the series of processes. On the other hand, when the ECU 15 determines not to terminate the charge (No in step S10), the process returns to step S1 to repeat the process.

Here, the ECU 15, if the radio communication is interrupted during charging, stops the transmission of power from the ground device 21 and disconnects the wireless communication while remaining the connection of the charging relay 12. That is, in a case where the radio communication is interrupted during charging in step S6, as illustrated by a dotted line in FIG. 2, although the ECU 15 stops power transmission as in step S7, the ECU 15 does not perform the process of turning OFF the charging relay 12 in step S8, and proceeds to step S9 to interrupt the wireless communication.

In addition, after resuming the radio connection, the ECU 15 resumes the transmission of power from the ground device 21 while the charge relay 12 is in the connected state. That is, after returning from step S10 to step S1 and resuming the wireless connectivity, as illustrated by a dotted line in FIG. 2, the ECU 15 does not need to turn ON the charge relay 12, so that the process of step S4 is not performed and the power transmission is started by step S5.

By executing the process described above, for each time the radio communication is interrupted, it is prevented from repeating ON/OFF of the charging relay 12, and thus it is possible to suppress the wear and tear in life of the charging relay 12.

### Disable Position Transmitter

In addition to the process of not performing ON/OFF of the charge relay 12 at the time of interruption/reconnection of radio communication, the position transmitter may be disabled (deactivated) at the time of reconnection of wireless communication in the Alignment Check in step S3.

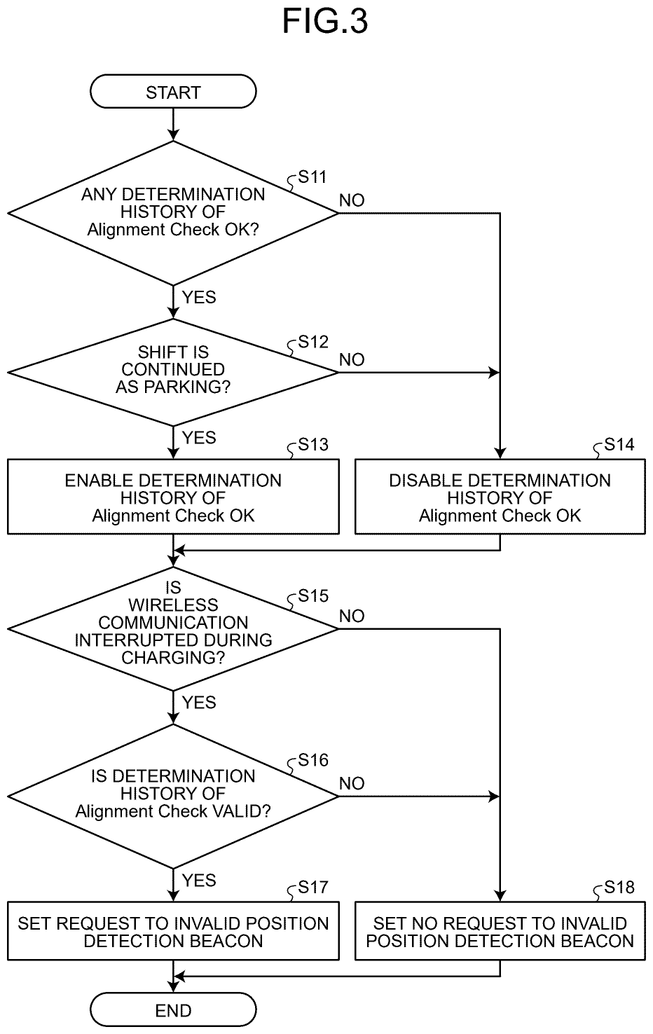

FIG. 3 is a flowchart illustrating a determination method of whether disable the position transmitter in the non-contact charge control device. The determination in FIG. 3, for example, is performed prior to the implementation of the Alignment Check in step S3.

First, the ECU 15 determines whether there is a history of determination of Alignment Check OK indicating that the in-vehicle device 11 and the ground device 21 are aligned in the Alignment Check (step S11). The ECU 15, when determining that there is a history of the determination of Alignment Check OK (Yes in step S11), the process proceeds to step S12, when the ECU 15 determines that there is no history of the determination of the Alignment Check OK (No in step S11), the process proceeds to step S14.

Subsequently, the ECU 15 determines whether the state of the shifting 14 is continued in parking (step S12). The ECU 15, if the position of the shift 14 is determined that the state of the parking is continued (Yes in step S12), the process proceeds to step S13. The ECU 15, if, however, the position of the shift 14 is determined that the state of the parking is not continued (No in step S12), the process proceeds to step S14.

In step S13, the ECU 15 enables (activates) the decision history (step S13) of the Alignment Check OK.

On the other hand, in step S14, the ECU15 disables (deactivates) the decision history of the Alignment Check OK (step S14).

Subsequently, the ECU 15 determines whether the radio communication is interrupted during the charging (step S15). If the ECU 15 determines that the radio communication is interrupted during charging (Yes in step S15), the process proceeds to step S16, and if the ECU 15 determines that the wireless communication is not interrupted during charging (No in step S15), the process proceeds to step S18.

Furthermore, the ECU 15 determines whether the determination history of the Alignment Check OK is valid (step S16). In step S13, if the determination history of the Alignment Check OK is enabled, the ECU 15 determines that the determination history of the Alignment Check OK is valid (Yes in step S16), and the process proceeds to step S17. On the other hand, in step S14, if the determination history of the Alignment Check OK is disabled, the ECU 15 determines that the history of the Alignment Check OK determination is disabled (No in step S16), and the process proceeds to step S18.

In step S17, the ECU 15 sets a flag indicating the invalidation request of the position transmitter to a state indicating that there is a request (step S17).

On the other hand, in step S18, the ECU 15 sets the flag indicating the invalidation request of the position transmitter to a state indicating that there is no request (step S18).

Performing the determination described above, in the Alignment Check in step S3, if the invalidation request of the position transmitter is in the state indicating that there is a request, the ECU 15 disables the position transmitter at the Alignment Check and performs the Alignment Check by using the position information at the time of the previous Alignment Check.

That is, after performing Alignment Check, if the wireless communication is interrupted during charging, after resuming the wireless connection, if the state that the vehicle 100 is parked (the state of the shift 14 is parked) is continued, the ECU 15 disables the position transmitter and resumes the transmission of power from the ground device 21

Here, the metal detecting unit 214 detects the metal foreign matter by detecting a change in the electric field. Therefore, when the electric field is changed when the charging relay 12 is turned ON and the voltage is applied, the metal detecting unit 214 may erroneously detect the metal foreign matter. Similarly, when the electric field is changed when applying a voltage to the position transmitter of the position transmitter unit 112, the metal detecting unit 214 may erroneously detect the metal foreign material. Furthermore, when a voltage is applied to the charging relay 12 and the position transmitter at the same time, a false detection by the metal detection unit 214 is more likely to occur.

Since the metal detecting unit 214 cannot identify the electric field generation source, such erroneous detection may occur. Further, in order to prevent erroneous detection, it is also possible to set a high parameter of the foreign material detection by the metal detection unit 214. In this case, however, there may be a case where the foreign material detection does not function sufficiently.

In contrast, when resuming the transmission of power after the radio communication is interrupted during charging, the ESC 15 disables the charging relay 12. Therefore, the voltage is applied to both charging relay 12 and the position transmitter at the same time, and thus, it is possible to prevent error detection occurs.

Further effects and variations can be readily derived by one skilled in the art. Thus, the broader aspects of the disclosure are not limited to the particular details and representative embodiments described and represented above. Accordingly, various modifications are possible without departing from the spirit or scope of the overall inventive concept defined by the appended claims and their equivalents.

According to the present disclosure, it is possible to realize a non-contact charge control device capable of suppressing the life of the charging relay is consumed.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A non-contact charge control device for a noncontact charge system that uses wireless communication to transmit power contactlessly from a power transmission device to a power receiving device, the non-contact charge control device comprising a processor configured to
when the wireless communication is interrupted during charging that power, transmitted from the power transmission device and received by a power receiving unit of the power receiving device, is charged to a battery,
stop the transmission of the power from the power transmission device and disconnect the wireless communication while maintaining a relay in a connecting state, the relay being provided for switching a connecting state between the power receiving unit and the battery, and
resume, after resuming the wireless communication, the power transmission from the power transmission device while maintaining the connecting state of the relay.

2. The non-contact charge control device according to claim 1, wherein
the power receiving device is an in-vehicle device mounted on a vehicle, and
the power transmission device is a ground device that transmits power from a ground to the vehicle.

3. The non-contact charge control device according to claim 2, wherein the processor is configured to, after applying a voltage to a position transmitter to transmit an electromagnetic wave for position detection, detecting the transmitted electromagnetic wave by the position detecting unit, and detecting a positional deviation between the power transmission device and the power receiving device, and if the wireless communication is interrupted during charging, disable, after resuming the wireless communication and if a state that vehicle parks is continuing, the position transmitter and resume the power transmission from the power transmission device.
